(19) United States
(12) Patent Application Publication
(10) Pub. No.: US 2013/0258178 A1
(43) Pub. Date: Oct. 3, 2013

(54) ILLUMINATION APPARATUS, IMAGING APPARATUS, COMPONENT MOUNTING APPARATUS, AND METHOD OF MANUFACTURING A SUBSTRATE

(71) Applicant: SONY CORPORATION, Tokyo (JP)

(72) Inventors: Akira Koshimura, Saitama (JP); Kazuhito Kunishima, Saitama (JP); Koya Nomoto, Saitama (JP)

(73) Assignee: Sony Corporation, Tokyo (JP)

(21) Appl. No.: 13/847,320

(22) Filed: Mar. 19, 2013

(30) Foreign Application Priority Data
Mar. 27, 2012 (JP) 2012-070870

(51) Int. Cl. H04N 5/225

(52) U.S. Cl. CPC H04N 5/2256; H04N 5/2251
USPC 348/370; 348/374; 29/407.04

(57) ABSTRACT

An illumination apparatus includes a light source section, an irradiation section, and a selection section. The light source section includes a light source configured to emit first-wavelength light having a first wavelength in order for an imaging apparatus to image a subject. The irradiation section is configured to convert the first-wavelength light from the light source into second-wavelength light having a second wavelength different from the first wavelength and to radiate the second-wavelength light to the subject. The selection section is configured to select the second-wavelength light as light to enter the imaging apparatus such that an image of the subject is captured using the second-wavelength light radiated to the subject.

### BACKGROUND

The present disclosure relates to an illumination apparatus that can be used, for example, in the case where electronic components are mounted on a substrate, to an imaging apparatus, to a component mounting apparatus, and to a method of manufacturing a substrate.

Japanese Patent No. 4221630 (hereinafter, referred to as Patent Document 1) describes a component mounting machine including a plurality of nozzles that suck electronic components and mount the sucked electronic components on a substrate. When a nozzle sucks an electronic component, a component recognition apparatus performs component recognition. The component recognition apparatus described in Patent Document 1 includes a first light source for radiating light from a back side of the component and a second light source for radiating light from a front side of the component. Further, a third light source for radiating light from a side surface side of the component is also provided. The component recognition is performed by appropriately using those light sources to capture an image of the electronic component. For the purpose of achieving highly accurate component recognition, a wavelength of light from the first light source or the second light source is set to be different from a wavelength of light from the third light source (paragraphs [0031]-[0035] in Patent Document 1).

### SUMMARY

In the component mounting machine as described above and the like, it is desirable to capture an image of a sucked electronic component with high accuracy. If the captured image of the electronic component is unclear, the accuracy of the component recognition is low.

In view of the above-mentioned circumstances, it is desirable to provide an illumination apparatus, an imaging apparatus, a component mounting apparatus, and a method of manufacturing a substrate, which enable, for example, an image of a subject such as an electronic component to be captured with high accuracy.

According to an embodiment of the present disclosure, there is provided an illumination apparatus including a light source section, an irradiation section, and a selection section.

The light source section includes a light source configured to emit first-wavelength light having a first wavelength in order for an imaging apparatus to image a subject.

The irradiation section is configured to convert the first-wavelength light from the light source into second-wavelength light having a second wavelength different from the first wavelength and to radiate the second-wavelength light to the subject.

The selection section is configured to select the second-wavelength light as light to enter the imaging apparatus such that an image of the subject is captured using the second-wavelength light radiated to the subject.

In this illumination apparatus, the first-wavelength light is converted into the second-wavelength light and the second-wavelength light is radiated to the subject. The second-wavelength light is selected as light to enter the imaging apparatus such that the image of the subject is captured using the second-wavelength light radiated to the subject. In this manner, based on the first-wavelength light emitted from the light source, the second-wavelength light used for the imaging is generated by the wavelength conversion. With this, for example, the image of the subject such as the electronic component can be captured with high accuracy with the second-wavelength light being the illumination light.

The irradiation section may be configured to radiate the second-wavelength light from a back side of the subject to the subject.

In this manner, the second-wavelength light may be used as transmitted illumination light. With this, the image of the subject by transmitted illumination can be captured with high accuracy.

The irradiation section may include a reflection plate that is provided on the back side of the subject and is configured to convert the first-wavelength light into the second-wavelength light and reflect the second-wavelength light to the subject.

In this manner, the reflection plate may convert the first-wavelength light into the second-wavelength light and reflect the second-wavelength light to the subject.

The light source section may be configured to emit the first-wavelength light to the reflection plate from a front side of the subject.

In this manner, the first-wavelength light may be emitted from the front side of the subject to the reflection plate. For example, even if part of the first-wavelength light is radiated to the subject, the reflection light from the subject does not enter the imaging apparatus. Therefore, a range of selection of arrangement positions of the light source section is wide and downsizing and the like of the illumination apparatus can be achieved.

The reflection plate may include a reflection surface that is provided perpendicular to a direction opposed to the subject and is configured to reflect the second-wavelength light to the subject in the opposed direction.

The reflection surface thus provided may reflect the second-wavelength light to the subject. For example, in comparison with a case where the reflection surface is provided obliquely to the direction opposed to the subject, it is possible to reduce the size of the reflection plate.

The light source section may include a different light source configured to radiate third-wavelength light having a third wavelength different from the first wavelength and the second wavelength to the subject. In this case, the irradiation section may be configured to absorb the third-wavelength light from the different light source. Further, the selection section may be configured to select the third-wavelength light as light to enter the imaging apparatus such that the image of the subject is captured using the third-wavelength light radiated to the subject.

In this illumination apparatus, the third-wavelength light is radiated from the different light source to the subject. The irradiation section absorbs the third-wavelength light. Further, the selection section selects the third-wavelength light as the light to enter the imaging apparatus. Therefore, in this illumination apparatus, the image of the subject can be captured with high accuracy, using the third-wavelength light radiated to the subject.

The light source section may be configured to radiate the third-wavelength light from the front side of the subject to the subject.

In this manner, the third-wavelength light may be used as reflected illumination light. With this, the image of the subject can be captured with high accuracy by reflected illumination.

The different light source may be provided flush with the light source.

With this, downsizing of the illumination apparatus can be achieved.

According to another embodiment of the present disclosure, there is provided an imaging apparatus including an imaging section, a light source section, an irradiation section, and a selection section.

The imaging section is configured to capture an image of a subject.

The light source section includes a light source configured to emit first-wavelength light having a first wavelength for the imaging.

The irradiation section is configured to convert the first-wavelength light from the light source into second-wavelength light having a second wavelength different from the first wavelength and to radiate the second-wavelength light to the subject.

The selection section is configured to select the second-wavelength light as light to enter the imaging section such that the image of the subject is captured using the second-wavelength light radiated to the subject.

According to still another embodiment of the present disclosure, there is provided a component mounting apparatus including a support unit, a retaining section, an imaging section, a light source section, an irradiation section, and a selection section.

The support unit is configured to support a substrate.

The retaining section is configured to be capable of retaining a component and mount the retained component on the substrate supported by the support unit.

The imaging section is configured to capture an image of the component retained by the retaining section.

The light source section includes a light source configured to emit first-wavelength light having a first wavelength for the imaging.

The irradiation section is configured to convert the first-wavelength light from the light source into second-wavelength light having a second wavelength different from the first wavelength and to radiate the second-wavelength light to the component.

The selection section is configured to select the second-wavelength light as light to enter the imaging section such that the image of the component is captured using the second-wavelength light radiated to the component.

The irradiation section may be provided to the retaining section on the back side of the component, and may include a reflection plate configured to convert the first-wavelength light into the second-wavelength light and reflect the second-wavelength light to the subject.

According to still another embodiment of the present disclosure, there is provided a method of manufacturing a substrate as follows.

A substrate is supported by a support unit.

A supplied component is retained by a retaining section.

First-wavelength light having a first wavelength is emitted in order for an imaging section to image the component retained by the retaining section.

The emitted first-wavelength light is converted into second-wavelength light having a second wavelength different from the first wavelength and the second-wavelength light is radiated to the component.

The second-wavelength light is selected as light to enter the imaging section, to thereby capture an image of the component using the second-wavelength light radiated to the component.

Component recognition is performed based on the image of the component that is captured using the second-wavelength light and the component retained by the retaining section is mounted on the substrate supported by the support unit based on a result of the component recognition.

As described above, according to the embodiments of the present disclosure, for example, it is possible to capture an image of a subject such as an electronic component with high accuracy.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic front view showing a component mounting apparatus according to a first embodiment of the present disclosure;

FIG. 2 is a plan view of the component mounting apparatus shown in FIG. 1;

FIG. 3 is a side view of the component mounting apparatus shown in FIG. 1;

FIG. 4 is a schematic view showing a mounting head unit, an imaging unit, an illumination unit according to this embodiment in an enlarged state;

FIG. 5 is a perspective view schematically showing the illumination unit according to this embodiment;

FIG. 6 is a schematic plan view showing a light source section according to this embodiment;

FIG. 7 is a schematic view for explaining an operation of the illumination unit as an illumination apparatus according to this embodiment;

FIG. 8 is a schematic view showing an illumination unit exemplified as a comparative example;

FIG. 9 is a schematic view for comparing a reflection plate according to this embodiment with a reflection plate exemplified as a comparative example;

FIG. 10 is a schematic view for explaining an operation of the illumination unit including a component mounting apparatus according to a second embodiment; and

FIG. 11 is a schematic plan view showing a light source section including an illumination unit according to the second embodiment.

### DETAILED DESCRIPTION OF EMBODIMENTS

Hereinafter, embodiments of the present disclosure will be described with reference to the drawings.

### First Embodiment

### Configuration of Component Mounting Apparatus

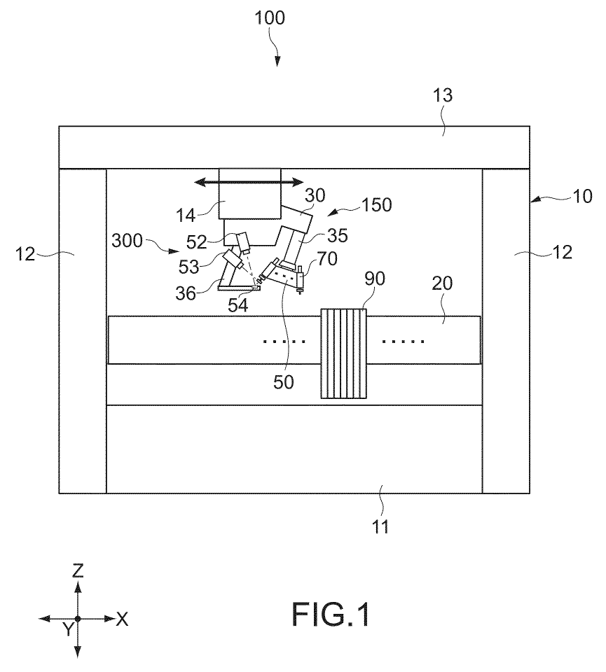

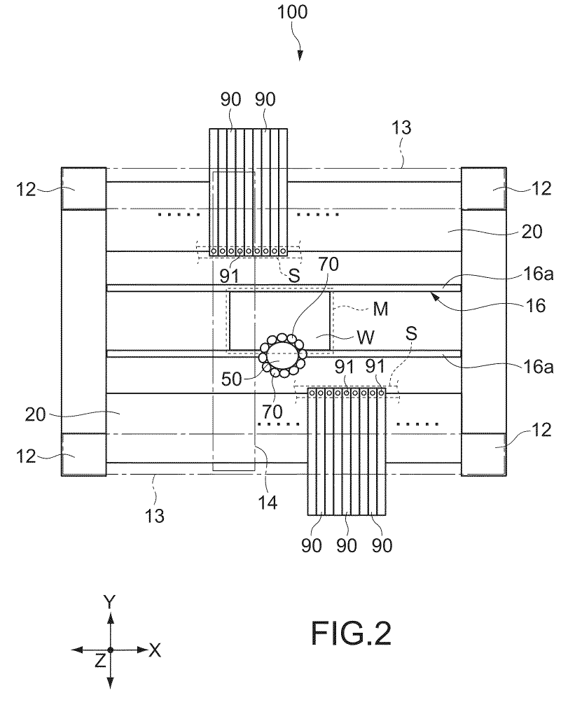

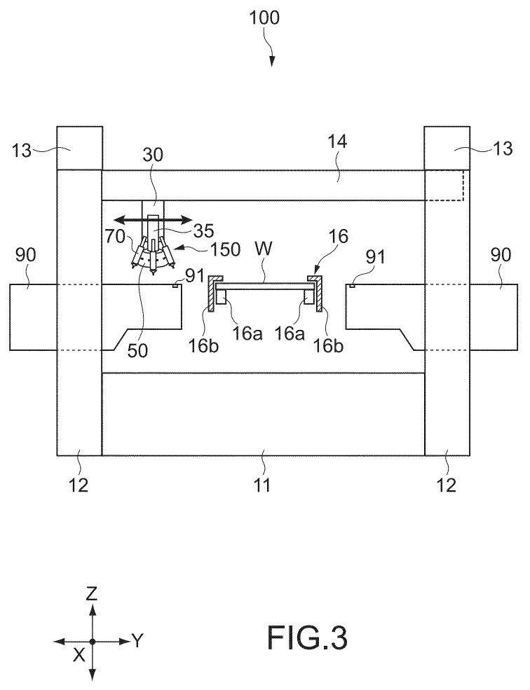

FIG. 1 is a schematic front view showing a component mounting apparatus 100 according to a first embodiment of the present disclosure. FIG. 2 is a plan view of the component mounting apparatus 100 shown in FIG. 1 and FIG. 3 is a side view thereof.

The component mounting apparatus 100 includes a frame 10, a mounting head unit 150, and tape feeder installation portions 20. The mounting head unit 150 retains an electronic component (not shown) and mounts the electronic component on a circuit substrate W (hereinafter, abbreviated as substrate) being a mounting target. In the tape feeder installation portions 20, tape feeders 90 are installed. Further, the component mounting apparatus 100 includes a conveyor unit 16 (see FIG. 2) that retains and conveys the substrate W.

The frame 10 includes a base 11 provided at a bottom and a plurality of support columns 12 fixed to the base 11. Upper portions of the plurality of support columns 12 are provided with, for example, two X-beams 13 along an X-axis in the drawings.

For example, between the two X-beams 13, a Y-beam 14 is provided along a Y-axis. To the Y-beam 14, the mounting head unit 150 is connected. The X-beams 13 and the Y-beam 14 are equipped with an X-axis movement mechanism and a Y-axis movement mechanism (not shown), respectively. Those movement mechanisms allow the mounting head unit 150 to move along the X-axis and the Y-axis. Although the X-axis movement mechanism and the Y-axis movement mechanism are typically constituted of ball-screw driving mechanisms, other mechanisms such as a belt driving mechanism may be employed.

A plurality of mounting head units 150 may be provided mainly in order to enhance productivity. In this case, the plurality of mounting head units 150 are independently driven in an X-axis direction and a Y-axis direction.

As shown in FIG. 2, the tape feeder installation portions 20 are provided on both of a front side (lower side in FIG. 2) and a rear side (upper side in FIG. 2) of the component mounting apparatus 100. The Y-axis direction in the drawings is front and rear directions of the component mounting apparatus 100.

In each of the tape feeder installation portions 20, the plurality of tape feeders 90 are arranged and installed along the X-axis direction. For example, 40 to 70 tape feeders 90 may be installed in the tape feeder installation portion 20. In this embodiment, 116 tape feeders 90 in total (58 on the front side and 58 on the rear side) may be installed.

Note that, although the tape feeder installation portions 20 are provided on both of the front side and the rear side of the component mounting apparatus 100, the tape feeder installation portions 20 may be provided on either one of the front side and the rear side.

The tape feeder 90 is formed to be long in the Y-axis direction. Although not shown in the drawings in detail, the tape feeder 90 includes a reel, and a carrier tape housing electronic components such as a capacitor, a resistor, a light-emitting diode (LED), and an integrated circuit (IC) packaging is wound around the reel. Further, the tape feeder 90 includes a mechanism for feeding the carrier tape in a stepwise manner. For each stepwise feeding, the electronic components are fed one by one.

As shown in FIG. 2, a supply window 91 is formed in an upper surface of an end portion of a cassette of the tape feeder 90. Through the supply window 91, the electronic components are supplied. An area in which the plurality of supply windows 91 are arranged, which is formed along the X-axis direction when the plurality of tape feeders 90 are arranged, serves as a supply area S of the electronic components.

Note that, in the carrier tape of one of the tape feeders 90, a large number of the same kind of electronic components are housed. Among the tape feeders 90 to be installed in the tape feeder installation portion 20, the same kind of electronic components may be housed over the plurality of tape feeders 90.

At a center portion of the component mounting apparatus 100 in the Y-axis direction, the conveyor unit 16 is provided. The conveyor unit 16 coveys the substrate W along the X-axis direction. For example, as shown in FIG. 2, an area of the conveyor unit 16 at an almost center position in the X-axis direction, above which the substrate W is supported by the conveyor unit 16, serves as a mounting area M. The mounting area M is an area in which mounting of an electronic component is performed by the mounting head unit 150 accessing the area.

The mounting head unit 150 includes a support 30, a base shaft 35, and a turret 50. The support 30 is connected to the Y-axis movement mechanism of the Y-beam 14. The base shaft 35 serves as a main rotating shaft supported by the support 30. The turret 50 is fixed to a lower end portion of the base shaft 35. Further, the mounting head unit 150 includes a plurality of nozzle units 70 connected to an outer peripheral portion of the turret 50. For example, 16 nozzle units 70 are provided. The number of nozzle units 70 is not limited.

Note that the support 30 may be connected to the X-axis movement mechanism. In this case, the Y-axis movement mechanism moves the X-axis movement mechanism and the mounting head unit 150 along the Y-axis direction.

The mounting head unit 150 is movable in the X-axis direction and the Y-axis direction as described above. The nozzle units 70 move between the supply area S and the mounting area M. Further, the nozzle units 70 move in the X-axis direction and the Y-axis direction within the mounting area M in order to perform mounting in the mounting area M.

While rotating the turret 50, the mounting head unit 150 causes the plurality of nozzle units 70 to respectively retain the plurality of electronic components continuously in a single step. Further, the plurality of electronic components sucked by the plurality of nozzle units 70 are continuously mounted on one substrate W.

Although the conveyor unit 16 is typically a belt type conveyor, the present disclosure is not limited thereto and any conveyor unit, for example, a roller type, a type in which a supporting mechanism that supports the substrate W moves slidably, or a non-contact type, may be employed. The conveyor unit 16 includes belt portions 16a and guide rails 16b laid along the X-axis direction. Due to the provision of the guide rails 16b, the substrate W is conveyed while misalignment of the conveyed substrate W in the Y-axis direction is corrected.

To the belt portions 16a, a lifting and lowering mechanism (not shown) is connected. On the belt portions 16a, the substrate W is disposed. In this state, by lifting the belt portions 16a in the mounting area M, the substrate W is retained while being sandwiched between the belt portions 16a and the guide rails 16b. In this case, the belt portions 16a and the guide rails 16b function as a retaining unit for a substrate. That is, the retaining unit forms part of the conveyor unit 16.

Further, the component mounting apparatus 100 according to this embodiment includes an imaging unit 300 including a plurality of cameras. The imaging unit 300 includes a first camera 52 and a second camera 53 for imaging the electronic components sucked by the nozzle units 70. The first camera 52 images the sucked electronic components through a mirror 54 from below. The second camera 53 images the sucked electronic components from the side. Based on the images captured by the first camera 52 and the second camera 53, component recognition is performed.

Based on the images captured by the first camera 52 and the second camera 53, a sucking state of the electronic components is recognized. For example, it is recognized whether or not the electronic components are normally sucked by the nozzle units 70. Further, orientations and the like of the electronic components sucked by the nozzle units 70 are recognized. Alternatively, it may be recognized whether or not the sucked electronic components have deficiencies, for example.

Further, the imaging unit 300 includes a substrate camera (not shown) for detecting an accurate position of the substrate W conveyed to the mounting area M. The substrate camera images the conveyed substrate W from above. From the captured image, an alignment mark provided to the substrate W is recognized. Then, based on a position of the alignment mark, a position of the substrate W is detected. After the accurate position of the substrate W is detected, the mounting head unit 150 starts mounting operations of the electronic components. The first camera 52, the second camera 53, and the mirror 54 are supported by a support table 36 connected to the X-axis movement mechanism and the Y-axis movement mechanism. Therefore, the first camera 52, the second camera 53, and the like are movable integrally with the mounting head unit 150. Further, the substrate camera is also connected to the X-axis movement mechanism and the Y-axis movement mechanism and movable integrally with the mounting head unit 150.

The first camera 52, the second camera 53, and the substrate camera are constituted of, for example, a charge coupled device (CCD) or a complementary metal oxide semiconductor (CMOS). Any other camera device may be used. Further, in this embodiment, as the first camera 52 and the second camera 53, cameras that capture monochrome images are used. However, cameras capable of capturing color images may be used.

In this embodiment, in order for the first camera 52 to image the electronic components, an illumination unit serving as an illumination apparatus according to this embodiment may be used. The illumination unit will be described later in detail. Note that, in this embodiment, the electronic component sucked by the nozzle unit 70 corresponds to a subject. Further, the first camera 52 corresponds to an imaging apparatus. In the entire component mounting apparatus 100, the first camera 52 corresponds to an imaging section.

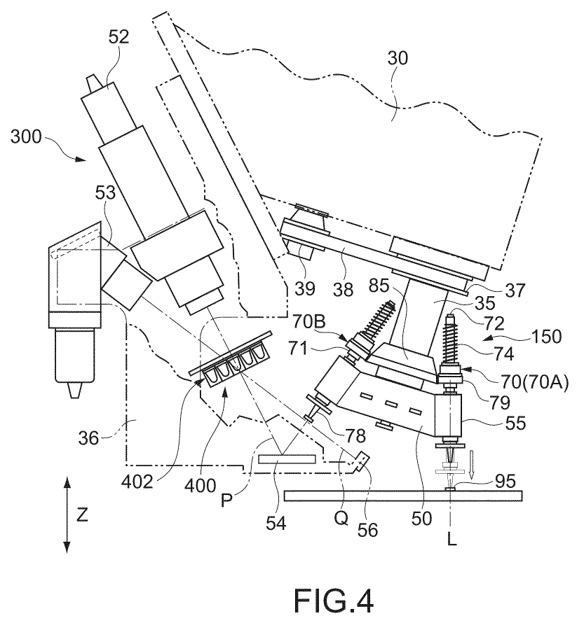

FIG. 4 is a schematic view showing the mounting head unit 150, the imaging unit 300, and the illumination unit according to this embodiment in an enlarged state.

Referring to FIG. 4, as described above, the mounting head unit 150 includes the support 30, the base shaft 35 supported by the support 30, and the turret 50 provided to the lower end portion of the base shaft 35. In the outer peripheral portion of the turret 50, the plurality of nozzle units 70 are supported. The plurality of nozzle units 70 are provided at equal intervals in a circumference with the base shaft 35 being a center. In FIG. 4, illustration of the nozzle units 70 is partially omitted (nozzle unit 70 positioned on front side in drawings is omitted).

As shown in FIG. 4, the support 30 supports the base shaft 35 orthogonally to a vertical direction (Z-axis direction). The support 30 rotatably supports the upper portion of the base shaft 35 by a bearing or the like. On a lower portion side of the support 30, a pulley 37 is fixed to the base shaft 35. The pulley 37 is connected to a pulley 39 through a belt 38, the pulley 39 being fixed to an output shaft of a motor (not shown). Therefore, rotational driving of the motor drives the base shaft 35.

The turret 50 rotates integrally with the base shaft 35 with the base shaft 35 being a center axis of rotation. The turret 50 has a shape such that a diameter decreases toward the position of the support 30 (upwardly) along the direction of the base shaft 35. That is, the turret 50 has a shape obtained by removing an apex portion from an almost circular cone shape. Therefore, an outer peripheral surface 55 of the turret 50 has a tapered shape.

To the outer peripheral portion of the turret 50, the plurality of nozzle units 70 are rotatably provided along a plane direction of the outer peripheral surface 55. Therefore, the nozzle units 70 are provided to each have a longitudinal direction L oblique to the base shaft 35. Each of the nozzle units 70 is provided at an angle such that, an upper end portion 72 in an opposite side thereof is closer to the base shaft 35 than a tip end portion 78 that retains an electronic component 95.

In this embodiment, the nozzle units 70 correspond to a retaining section that retains a plurality of electronic components 95 supplied to the supply area S and mounts the retained electronic components 95 on the substrate W supported by the support unit.

Each of the nozzle units 70 includes a nozzle 71 and a nozzle holder (not shown) covering an outer circumference of the nozzle 71. The nozzle holder is rotatably connected to the turret 50 by a bearing (not shown) at both end portions of the nozzle holder.

In the tip end portion 78 of the nozzle 71, a hole (not shown) is formed. The size of the hole in the tip end portion 78 is set to be a size to retain the electronic component smaller than the size of 1 mm*1 mm, for example. A plurality of holes may be provided.

On the upper portion of the nozzle 71, a coil spring 74 is provided. For example, a pressing roller of a nozzle driving unit (not shown) downwardly pushes the upper end portion 72 of the nozzle 71 against a biasing force of the coil spring 74. When the nozzle 71 moves and descends within the nozzle holder, the coil spring 74 is contracted. When the press by the pressing roller is released, the nozzle 71 ascends due to a returning force of the coil spring 74. As the nozzle driving unit, for example, a well-known mechanism as shown in Japanese Patent Application Laid-open No. 2005-150638 may be used.

The base shaft 35 is supported by the support 30 such that the longitudinal direction of at least one nozzle unit 70 of the plurality of nozzle units 70 is along the vertical direction (Z-axis direction). Out of the plurality of nozzle units 70, one provided to have the longitudinal direction along the Z-axis direction is a nozzle unit 70A selected for mounting the electronic component on the substrate W.

By a rotation of the turret 50, any one nozzle unit 70A is selected. The selected nozzle unit 70A accesses the supply window 91 of the tape feeder 90, sucks and retains an electronic component, moves to the mounting area M, and then descends. In this manner, the electronic component is mounted on the substrate W.

The position of the nozzle unit 70A provided to have the longitudinal direction L along the Z-axis direction is referred to as a nozzle operation position. The nozzle unit 70A located at the nozzle operation position sucks the electronic component and mounts the electronic component on the substrate in the mounting area M.

At a position of the base shaft 35 that is close to the turret 50, a driving gear 85 for rotating the plurality of nozzle units 70 is provided. The driving gear 85 is provided to be rotatable with respect to the base shaft 35. A rotational driving mechanism (not shown) drives the driving gear 85 to rotate independently of the base shaft 35.

Each of the plurality of nozzle units 70 is provided with a gear 79 that is engaged to the driving gear 85. The gear 79 is fixed to the nozzle unit 70 such that the longitudinal direction L of the nozzle unit 70, to which the gear 79 is mounted, is along an axial direction. When the driving gear 85 rotates, a rotational force of the driving gear 85 is transmitted to each gear 79 and the nozzle units 70 rotate. For example, when the orientation of the sucked electronic component 95 is corrected, the nozzle unit 70 is rotated.

Note that the gears 79 provided to the nozzle units 70 may be arranged offsetting each other in the longitudinal directions L of the nozzle units 70. For example, the gears 79 are arranged offsetting each other in the longitudinal directions L in a zigzag manner. With this, arrangement density of the nozzle units 70 can be increased and downsizing of the mounting head unit 150 can be achieved.

As shown in FIG. 4, the base shaft 35 is supported obliquely to the vertical direction, and hence the nozzle unit 70A located at the nozzle operation position is at a lowest position in the vertical direction. The nozzle unit 70 located at a position 180 degrees opposite to the nozzle operation position is at a highest position in the vertical direction.

The position opposite to the nozzle operation position is referred to as an imaging position. Further, the nozzle unit 70 located at the imaging position is referred to as a nozzle unit 70B. The nozzle unit 70B located at the imaging position is imaged by the first camera 52 and the second camera 53.

At the imaging position, the nozzle unit 70B is located at the high position in the vertical direction, and hence it becomes easy for the first camera 52 and the second camera 53 to perform the imaging and a retaining state and the like of the component can be easily checked. Further, mounting and the like of the first camera 52 and the second camera 53 that image the nozzle unit 70B also become easy. The range of selection for mounting positions of the first camera 52 and the second camera 53 is enlarged, and it becomes possible to achieve downsizing of the component mounting apparatus 100 by appropriately setting the mounting positions.

The first camera 52 images the electronic component 95 sucked by the nozzle unit 70B located at the imaging position from below. In this embodiment, as shown in FIG. 4, the first camera 52 is provided to be oriented downwards at a position higher than the mounting head unit 150 in the Z-axis direction. Below the first camera 52, the mirror 54 is provided. An imaging optical axis P of the first camera 52 is directed by the mirror 54 to the lower portion of the electronic component 95 along the longitudinal direction of the nozzle unit 70B. Based on light entering the first camera 52 along the imaging optical axis P, an image of the electronic component 95 is generated.

Note that, in this embodiment, a lower side of the electronic component 95 sucked by the nozzle unit 70B means a front side of the electronic component 95. That is, in an orientation along the longitudinal direction of the nozzle unit 70B, an opposite side of the nozzle unit 70B becomes the front side of the sucked electronic component 95. Therefore, the first camera 52 captures an image of the front side of the electronic component 95. In the longitudinal direction of the nozzle unit 70B, a side opposite to the front side becomes a back side. That is, in an orientation along the longitudinal direction of the nozzle unit 70B, a side on which the nozzle unit 70B is positioned becomes a back side of the sucked electronic component 95.

The second camera 53 images the electronic component 95 sucked by the nozzle unit 70B located at the imaging position from the side. In this embodiment, as shown in FIG. 4, the second camera 53 is provided to face a side surface of the electronic component 95. An imaging optical axis Q of the second camera 53 is caused to directly correspond to the side surface of the electronic component 95. A side-surface light source 56 is provided on the imaging optical axis Q. An image of a side surface of the electronic component 95 is captured using light from the side-surface light source 56. As the side-surface light source 56, for example, an LED is used.

### Configuration of Illumination Apparatus

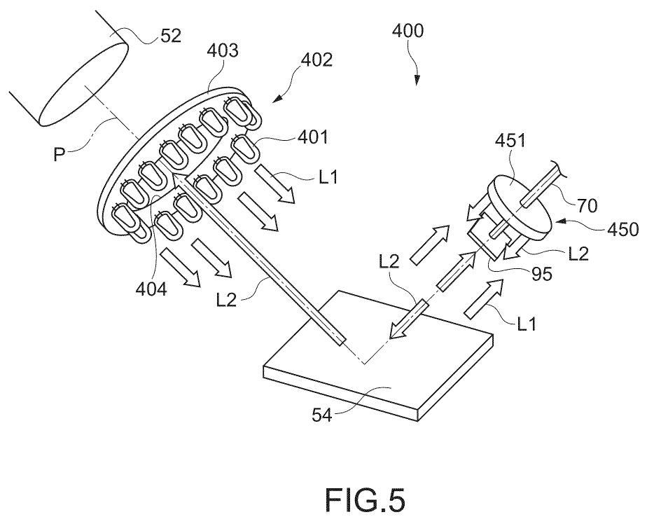

An illumination unit 400 serving as an illumination apparatus according to this embodiment will be described. FIG. 5 is a perspective view schematically showing the illumination unit 400 according to this embodiment. The illumination unit 400 is used mainly for the first camera 52 imaging the electronic component 95. Note that the above-mentioned side-surface light source 56 may operate as part of the illumination unit 400.

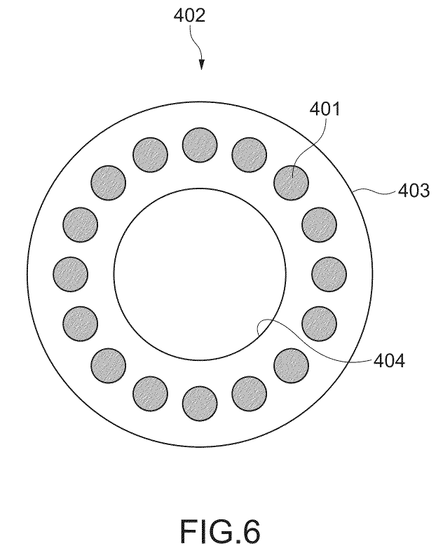

The illumination unit 400 includes a light source section 402 including a light source 401 that emits first-wavelength light L1 in order for the first camera 52 to image the electronic component 95. FIG. 6 is a schematic plan view showing the light source section 402 according to this embodiment.

The light source section 402 includes a support portion 403, an opening 404 formed in the support portion 403, and a plurality of light sources 401 provided around the opening 404. The support portion 403 is a plate-like member and has a circular shape. As the support portion 403, a substrate on which a wiring (not shown) is formed is used and the material, the kind, and the like are not limited. Further, the shape of the support portion 403 is not limited to the circular shape and may be arbitrarily designed. Further, the shape, size, and the like of the opening 404 may also be arbitrarily selected.

As the light sources 401 according to this embodiment, the light emitting diodes (LEDs) are used. The plurality of light sources 401 emit, as the first-wavelength light L1, near-infrared light having a wavelength of about 940 nm. Note that the number of light sources 401 is not limited. Further, the light sources 401 are not limited to the LEDs.

As shown in FIG. 4 and the like, the light source section 402 is located at a position such that the imaging optical axis P of the first camera 52 passes through the opening 404. Further, the light source section 402 is located at a position such that the first-wavelength light L1 from the light sources 401 is mainly emitted in a direction almost the same as the imaging optical axis P. In this embodiment, the support portion 403 is provided to be almost orthogonal to the imaging optical axis P.

The first-wavelength light L1 emitted from the light sources 401 is reflected by the mirror 54 and emitted to the electronic component 95. That is, the light source section 402 according to this embodiment includes the mirror 54 and emits the first-wavelength light L1 from the front side of the electronic component 95 to the electronic component 95 and a reflection plate 451, which will be described later.

Further, the illumination unit 400 includes an irradiation section 450 that converts the first-wavelength light L1 having a first wavelength from the light sources 401 into second-wavelength light L2 having a second wavelength different from the first wavelength and radiates the second-wavelength light L2 to the electronic component 95. In this embodiment, the irradiation section 450 radiates the second-wavelength light L2 to the electronic component 95 from the back side of the electronic component 95. Therefore, the second-wavelength light L2 is used as transmitted illumination light. As a result, the first camera 52 captures an image of the electronic component 95 by transmitted illumination.

As shown in FIG. 5, the irradiation section 450 according to this embodiment is located on the back side of the electronic component 95 and includes the reflection plate 451 that converts the first-wavelength light L1 into the second-wavelength light L2 and reflects the second-wavelength light L2 to the electronic component 95. The first-wavelength light L1 emitted from the front side of the electronic component 95 is converted by the reflection plate 451 into the second-wavelength light L2 and the second-wavelength light L2 is radiated to the electronic component 95 from the back side. The second-wavelength light L2 radiated to the electronic component 95 travels on the imaging optical axis P of the first camera via the mirror 54.

The reflection plate 451 is typically mounted to the nozzle unit 70 as a reflector. However, the present disclosure is not limited to the configuration and the reflection plate 451 may be provided independently of the nozzle unit 70.

The reflection plate 451 according to this embodiment is formed of a member containing an infrared (IR)-excited phosphor that is excited by a near-infrared light and emits a visible light. As the IR-excited phosphor, for example, a rare-earth oxysulfide phosphor or a rare-earth oxide phosphor is used. In addition to this, a well-known IR-excited phosphor may appropriately be used. For example, solid-state one obtained by mixing powder of an IR-excited phosphor into a transparent resin or glass is used as the reflection plate 451.

In this embodiment, the first-wavelength light L1 having a wavelength of about 940 nm is converted by the reflection plate 451 into the second-wavelength light L2 being green light having a wavelength of about 525 nm. This visible light L2 is radiated from the back side of the electronic component 95. Note that the wavelength of the second-wavelength light L2 to be radiated after conversion is not limited. For example, as the second-wavelength light L2, blue light having a wavelength of about 480 or red light having a wavelength of about 660 nm may be emitted. By appropriately selecting the IR-excited phosphor, the wavelength of the second-wavelength light L2 can be set.

The illumination unit 400 according to this embodiment includes a selection section that selects the second-wavelength light L2 as light to enter the first camera 52 such that an image of the electronic component 95 is imaged using the second-wavelength light L2 radiated to the electronic component 95.

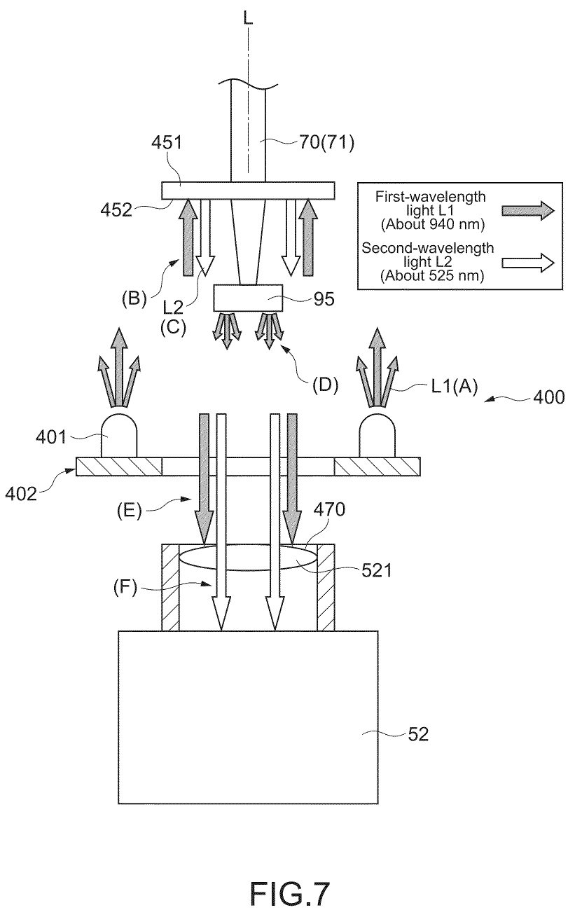

In this embodiment, as the selection section, a wavelength selecting filter 470 (see FIG. 7) is used. In this embodiment, the wavelength selecting filter 470 in a film form is formed on a surface of a lens 521 of the first camera 52. The wavelength selecting filter 470 is formed on the lens 521 by, for example, deposition. The formation method for the wavelength selecting filter 470 is not limited.

The wavelength selecting filter 470 shields (absorbs) the first-wavelength light L1 and transmits therethrough the second-wavelength light L2. With this, the second-wavelength light L2 is selected as incident light into the first camera 52. As a result, an image of the electronic component 95 is captured using the second-wavelength light L2 radiated to the electronic component 95. Note that the shielding of the first-wavelength light L1 is not limited to the absorption of the first-wavelength light L1.

As the wavelength selecting filter 470, an optical element such as a filter plate may be used. Such a filter plate may be provided on the imaging optical axis P. Alternatively, such a filter plate may be detachably provided in front of the lens 521 of the first camera 52.

The component mounting apparatus 100 includes a control system (not shown). The control system includes a main controller (or host computer). The mounting head unit 150, the tape feeder 90, the conveyor unit 16, the imaging unit 300, the illumination unit 400, an input unit, a display unit, and the like are electrically connected to the main controller.

The movement mechanisms and the mounting head unit 150 are each provided with a motor (not shown) installed therein and a driver that drives the motor. By the main controller outputting control signals to those drivers, the drivers drive the movement mechanisms and the mounting head unit 150 according to the control signals. Operations of the imaging unit 300 and the illumination unit 400 are also controlled by the main controller. The main controller controls the respective units of the component mounting apparatus 100 according to a predetermined program or an instruction from an operator.

The input unit is, for example, an apparatus to be operated by the operator in order for the operator to input information necessary for mounting processing into the main controller. The display unit is, for example, an apparatus that displays information inputted by the operator via the input unit, information necessary for the input operation, and other necessary information.

The main controller has computer functions, for example, a central processing unit (CPU), a random access memory (RAM), and a read-only memory (ROM) and functions as a control unit. The main controller may be embodied by a programmable logic device (PLD) such as a field programmable gate array (FPGA) or another device such as an application specific integrated circuit (ASIC).

### Operation of Illumination Apparatus

FIG. 7 is a schematic view for explaining an operation of the illumination unit 400 serving as the illumination apparatus according to this embodiment. As described above, in this embodiment, the first-wavelength light L1 is emitted via the mirror 54 to the front side of the electronic component 95. In FIG. 7, for easy understanding of how the first-wavelength light L1 and the second-wavelength light L2 are radiated, illustration of the mirror 54 is omitted. That is, in FIG. 7, at the position opposed to the electronic component 95, the light source section 402 is shown. Note that the light source section 402 may be provided in the position relationship shown in FIG. 7 as an example.

In the supply area S shown in FIG. 2, the nozzle unit 70A located at the nozzle operation position sucks the electronic component 95. The turret 50 rotates and the nozzle unit 70A sucking the electronic component 95 is moved to the imaging position. Note that, also while the nozzle unit 70A is moving to the imaging position, the nozzle unit 70A subsequently located at the nozzle operation position sucks an electronic component 95.

In order for the first camera 52 to image the electronic component 95 sucked by the nozzle unit 70B, the first-wavelength light L1 is emitted from the light sources 401 (arrow A). The first-wavelength light L1 is emitted from the front side of the electronic component 95 to the reflection plate 451.

As shown in FIG. 7, the reflection plate 451 according to this embodiment is provided perpendicular to the direction opposed to the electronic component 95. The reflection plate 451 includes a reflection surface 452 that reflects the second-wavelength light L2 to the electronic component 95 in the opposed direction. The direction opposed to the electronic component 95 means the longitudinal direction L of the nozzle unit 70B located at the imaging position in this embodiment. In other words, the direction opposed to the electronic component 95 means a direction of the imaging optical axis of the first camera 52.

That is, in this embodiment, the first-wavelength light L1 is emitted in a direction almost perpendicular to the reflection surface 452 (arrow B). On the reflection surface 452, the first-wavelength light L1 is converted into the second-wavelength light L2 and the second-wavelength light L2 is reflected to the electronic component 95. The second-wavelength light L2 is radiated to the electronic component 95 in the direction almost perpendicular to the reflection surface 452 (arrow C).

In this embodiment, part of the first-wavelength light L1 emitted from the light sources 401 is also radiated to the electronic component 95. The first-wavelength light L1 radiated to the electronic component 95 is reflected by the electronic component 95 (arrow D). Therefore, in this embodiment, the second-wavelength light L2 radiated from the back side of the electronic component 95 to the electronic component 95 and the first-wavelength light L1 reflected by the electronic component 95 travel on the imaging optical axis toward the first camera 52 (arrow E).

The wavelength selecting filter 470 formed on the surface of the lens 521 of the first camera 52 as the selection section absorbs the first-wavelength light L1 and transmits therethrough the second-wavelength light L2. With this, the second-wavelength light L2 is incident upon an imaging sensor provided inside the first camera 52 (arrow F). As a result, an image of the electronic component 95 is captured using the second-wavelength light L2 radiated to the electronic component 95. The second-wavelength light L2 is used as the transmitted illumination light, and hence the image of the electronic component 95 by the transmitted illumination is captured.

Based on the image of the electronic component 95 that is captured by the first camera 52, the component recognition is performed. Based on a result of the component recognition, the electronic component 95 retained by the nozzle unit 70 is mounted on the substrate W supported by the support unit. For example, based on the result of the component recognition, information for correcting the orientation of the electronic component 95 is calculated. Based on the information, the driving gear 85 shown in FIG. 4 is rotated and the nozzle units 70 are rotated by a predetermined angle. With this, the orientation of the electronic component 95 is corrected.

The correction of the orientation of the electronic component 95 is performed when the nozzle 71 sucking the electronic component 95 moves to the nozzle operation position again. Meanwhile, the imaging and the component recognition by the imaging unit 300 are performed on the nozzle unit 70B located at the imaging position. Therefore, in this embodiment, the suction of the electronic component 95 in the supply area S and the mounting of the electronic component 95 in the mounting area M are performed while the mounting head unit 150 is reciprocated between the supply area S and the mounting area M. That is, the mounting head unit 150 does not move to a predetermined area for the component recognition. As a result, a processing period of time for mounting a component can be reduced.

When the mounting head unit 150 mounts a predetermined number of electronic components 95 on the substrate W, the substrate W is unloaded by the conveyor unit 16 to an outside of the component mounting apparatus 100. With this, the substrate W on which the electronic component 95 is mounted is manufactured.

As described above, in the component mounting apparatus 100 according to this embodiment, the illumination unit 400 converts the first-wavelength light L1 into the second-wavelength light L2 and radiates the second-wavelength light L2 to the electronic component 95. The second-wavelength light L2 is selected as the light to enter the first camera 52 such that the image of the electronic component 95 is captured by the second-wavelength light L2 radiated to the electronic component 95. In this manner, based on the first-wavelength light L1 emitted from the light sources 401, the second-wavelength light L2 used for the imaging is generated by the wavelength conversion. With this, for example, it is possible to capture the image of the electronic component 95 with high accuracy with the second-wavelength light L2 being illumination light.

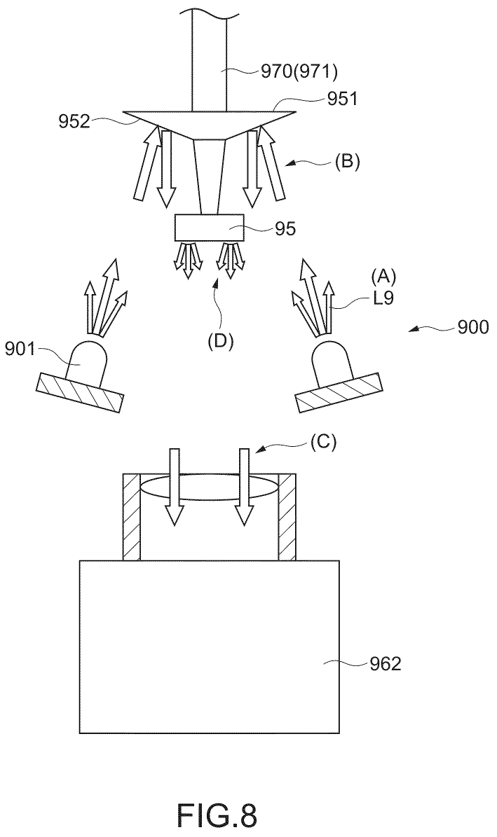

FIG. 8 is a schematic view showing an illumination unit 900 exemplified as a comparative example. The illumination unit 900 includes light sources 901 and a reflection plate 951. Each of the light sources 901 emits transmitted illumination light. The reflection plate 951 is mounted to a nozzle 971 to be located on a back side of an electronic component 95.

Transmitted illumination light L9 is radiated from the light source 901 to the reflection plate 951 (arrow A). The reflection plate 951 reflects the transmitted illumination light L9 and the transmitted illumination light L9 is radiated from the back side of the electronic component 95 (arrow B). The transmitted illumination light L9 radiated to the electronic component 95 from the back side is inputted to a camera 962 (arrow C). With this, the image of the electronic component 95 is captured.

In the illumination unit 900, the position of the light source 901 is adjusted such that the transmitted illumination light L9 does not directly radiate to the electronic component 95. That is, the light source 901 is located at a position such that the electronic component 95 is irradiated with the transmitted illumination light L9 in a direction orthogonal to the opposed direction from an outside. The reflection plate 951 is provided obliquely to the direction opposed to the electronic component 95 and includes a reflection surface 952 that reflects the obliquely entering transmitted illumination light L9 to the electronic component 95. The reflection surface 952 radiates the transmitted illumination light L9 to the electronic component 95 from the back side.

The reason why the positions of the light sources 901 are adjusted in the illumination unit 900 according to the comparative example is that if the transmitted illumination light L9 directly radiates to the electronic component 95, the reflection light enters the camera (arrow D). If so, the contrast of the image of the electronic component 95 that is captured by the transmitted illumination is lowered and, for example, recognition accuracy of an outer shape of the electronic component is lowered.

Even if the positions of the light sources 901 are appropriately adjusted, the transmitted illumination light L9 directly radiates to the electronic component in many cases. Also in these cases, the contrast of the image of the electronic component 95 is lowered.

In contrast, in the illumination unit 400 according to this embodiment, the reflection plate 451 converts the first-wavelength light L1 into the second-wavelength light L2 and radiates the second-wavelength light L2 to the electronic component 95 from the back side. Further, the second-wavelength light L2 is selected as the light to enter the first camera 52. Therefore, even if the first-wavelength light L1 directly radiates to the electronic component 95, the reflection light does not enter the first camera 52. As a result, a highly accurate image with good contrast by the transmitted illumination can be captured.

Further, it becomes unnecessary to adjust the positions of the light sources 401 such that the first-wavelength light L1 does not directly radiate to the electronic component 95. Therefore, a range of selection of configurations, arrangement positions, and the like of the light source section 402 including the light sources 401 is enlarged. With this, by appropriately setting the arrangement positions of the light source section 402 and the like, downsizing of the illumination unit 400 can be achieved.

For example, in the illumination unit 900 according to the comparative example, it is considered difficult to achieve a configuration in which the transmitted illumination light L9 is emitted to the reflection plate 951 via the mirror. That is because it is highly likely that the transmitted illumination light L9 directly radiates to the electronic component 95. Therefore, in the illumination unit 900 of the comparative example, it is necessary to provide the light sources 901 below the electronic component 95. In this embodiment, such a limitation is not imposed.

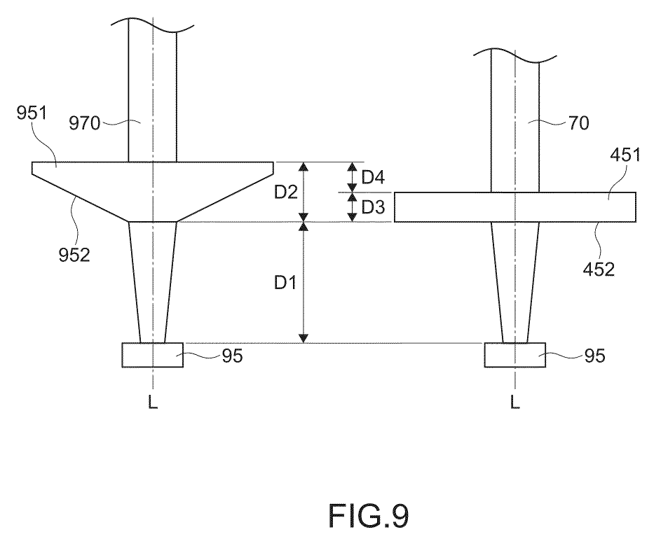

FIG. 9 is a schematic view for comparing the reflection plate 451 according to this embodiment with the reflection plate 951 exemplified as the comparative example. The reflection plate 451 according to this embodiment includes the reflection surface 452 provided perpendicular to the direction opposed to the electronic component 95 (longitudinal direction L of each nozzle unit). The reflection plate 951 according to the comparative example includes the reflection surface 952 provided obliquely to the direction opposed to the electronic component 95. Therefore, the reflection plate 451 according to this embodiment has a flat shape and the reflection plate 951 according to the comparative example has a circular cone shape. Further, a distance D1 between a suction surface of the electronic component 95 and the reflection surface 952 is equal to a distance D1 between a suction surface of the electronic component 95 and the reflection surface 452.

As shown in FIG. 9, comparing a thickness D2 of the reflection plate 951 according to the comparative example with a thickness D3 of the reflection plate 451 according to this embodiment, the former is larger than the latter. In other words, the reflection plate 951 according to the comparative example is larger in thickness because the reflection surface 952 is obliquely formed (by thickness denoted by D4 of FIG. 9). As a result, the nozzle unit 70 to which the reflection plate 451 according to this embodiment is attached can be shorter than a nozzle unit 970 according to the comparative example. Therefore, downsizing of the mounting head unit 150 can be achieved.

### Second Embodiment

A component mounting apparatus according to a second embodiment of the present disclosure will be described. In the following, descriptions of the same configurations and actions as those in the component mounting apparatus 100 described in the above embodiment will be omitted or simplified.

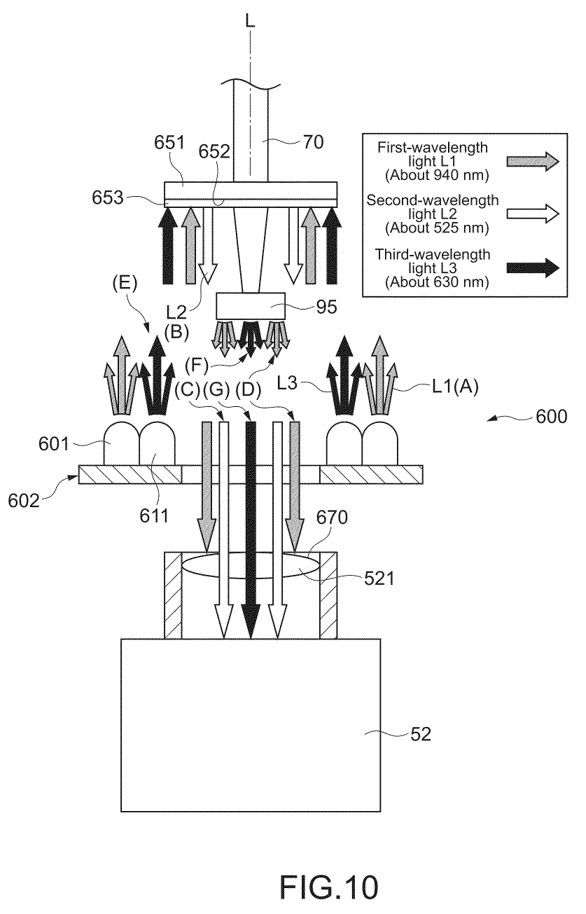

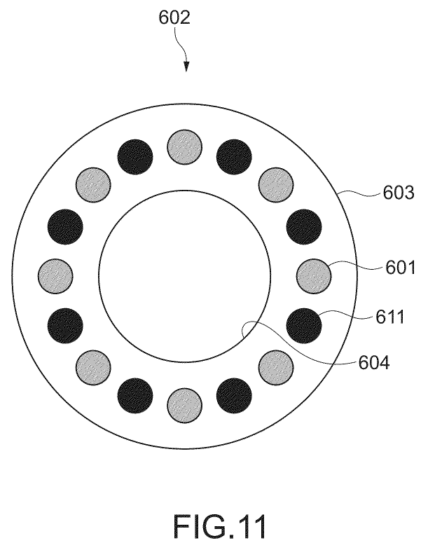

FIG. 10 is a schematic view for explaining an operation of an illumination unit 600 serving as an illumination apparatus including a component mounting apparatus according to this embodiment. FIG. 11 is a schematic plan view showing a light source section 602 of the illumination unit 600 according to this embodiment.

In this embodiment, imaging of the electronic component 95 by the transmitted illumination and imaging of the electronic component 95 by reflected illumination become possible. As shown in FIG. 11, the light source section 602 is provided with two kinds of light sources around an opening 604 formed in a support portion 603. As one of the two kinds of light sources, there are provided light sources 601 that emit the first-wavelength light L1 having a wavelength of about 940 nm, which are used also in the above-mentioned embodiment. The first-wavelength light L1 is converted into second-wavelength light L2 having a wavelength of about 525 nm and the second-wavelength light L2 is radiated from the back side of the electronic component 95. Hereinafter, the light sources 601 are referred to as the transmitted illumination light sources 601.

The light source section 602 is provided with, as the other of the two kinds of light sources, different light sources 611 that radiate third-wavelength light L3 having a third wavelength different from the first wavelength and the second wavelength to the electronic component 95. In this embodiment, as the third-wavelength light L3, red light having a wavelength of about 630 nm is emitted. Note that the wavelength of the third-wavelength light L3 is not limited. The different light sources 611 are used for capturing an image of the electronic component 95 by the reflected illumination. Hereinafter, the different light sources 611 are referred to as reflected illumination light sources 611.

As shown in FIG. 11, the plurality of transmitted illumination light sources 601 and the plurality of reflected illumination light sources 611 are provided flush with the support portion 603. Further, the plurality of transmitted illumination light sources 601 and the plurality of reflected illumination light sources 611 are alternately arranged around the opening 604. However, the arrangement positions, the number, and the like of the transmitted illumination light sources 601 and the reflected illumination light sources 611 are not limited.

In FIG. 10, as in FIG. 7, illustration of the mirror is omitted. That is, actually, the support portion 603 is provided with the support portion 603 at the position shown in FIG. 4, and the transmitted illumination light sources 601 and the reflected illumination light sources 611 are arranged in the support portion 603. Therefore, the third-wavelength light L3 is radiated from the front side of the electronic component 95 to the electronic component 95 via the mirror. Note that the light source section 602 may be provided in a position relationship shown in FIG. 10 as an example.

Further, a reflection surface 652 of a reflection plate 651 serving as the irradiation section according to this embodiment is provided with a wavelength selecting filter 653 that absorbs the third-wavelength light L3. The wavelength selecting filter 653 absorbs the third-wavelength light L3 and transmits therethrough the first-wavelength light L1 and the second-wavelength light L2. The filter film serving as the wavelength selecting filter 653 may be formed in the reflection surface 652 or an optical element such as a filter plate may be provided in front of the reflection surface 652.

As the selection section according to this embodiment, a film-like wavelength selecting filter 670 is used, the film-like wavelength selecting filter 670 being capable of selecting the third-wavelength light L3 as light to enter the first camera 52 such that an image of the electronic component 95 is captured using the third-wavelength light L3 radiated to the electronic component 95. That is, the wavelength selecting filter 670 according to this embodiment shields the first-wavelength light L1 and transmits therethrough the second-wavelength light L2 and the third-wavelength light L3.

In the case where the image of the electronic component 95 is captured, a transmitted-illumination imaging mode and a reflected-illumination imaging mode are appropriately selected according to, for example, an instruction by the operator. Depending on the mode selection, the illumination unit 400 operates to capture an image of the electronic component 95.

In the transmitted-illumination imaging mode, almost the same operations described in the first embodiment are performed. The first-wavelength light L1 is radiated from the transmitted illumination light sources 601 (arrow A) and converted by the reflection plate 651 into the second-wavelength light L2 and the second-wavelength light L2 is radiated to the electronic component 95 from the back side (arrow B). At this time, the first-wavelength light L1 and the second-wavelength light L2 transmit through the wavelength selecting filter 653 provided on the reflection surface 652.

The second-wavelength light L2 radiated to the electronic component 95 transmits through the wavelength selecting filter 670 formed in the lens 521 and enters the first camera 52 (arrow C). The first-wavelength light L1 reflected by the electronic component 95 and the like is absorbed by the wavelength selecting filter 670 and does not enter the first camera 52 (arrow D). With this, the image of the electronic component 95 is captured with high accuracy with the second-wavelength light L2 being the transmitted illumination.

In the reflected-illumination imaging mode, the third-wavelength light L3 is radiated from the reflected illumination light sources 611 (arrow E). The third-wavelength light L3 is directly radiated to the electronic component 95 and the reflection light travels toward the first camera 52 on the imaging axis (arrow F). The third-wavelength light L3 reflected by the electronic component 95 transmits through the wavelength selecting filter 670 formed in the lens 521 and enters the first camera 52 (arrow G). Note that the third-wavelength light L3 not radiated to the electronic component 95 but emitted toward the reflection plate 651 is absorbed by the wavelength selecting filter 653 provided in the reflection surface 652. Therefore, the third-wavelength light L3 is not reflected by the reflection plate 651 and, of course, that light does not enter the first camera 52. As a result, the image of the electronic component 95 is captured with high accuracy with the third-wavelength light L3 being the reflected illumination.

As described above, in the illumination unit 600 according to this embodiment, the image of the electronic component 95 by the transmitted illumination and the image of the electronic component 95 by the reflected illumination can be captured with accuracy. For example, by appropriately switching the imaging mode based on the shape, color, material, and the like of the electronic component 95, the electronic component 95 can be imaged. As a result, it becomes possible to recognize the electronic component 95 with high accuracy.

As also discussed in the first embodiment, the degree of free in design relating to the arrangement positions and the like of the transmitted illumination light sources 601 is high. Therefore, the transmitted illumination light sources 601 can be provided flush with the reflected illumination light sources 611 for directly radiating the third-wavelength light L3 to the electronic component 95. With this, simplification and downsizing of the configuration of the illumination unit 600 can be achieved.

Further, the transmitted illumination light sources 601 and the reflected illumination light sources 611 can be mounted on a single substrate and a configuration of switching lighting of both of the light sources on an electrical circuit also becomes possible. Further, in order to capture the image of the transmitted illumination and the image of the reflected illumination, it is unnecessary to exchange the reflection plate or the nozzle itself, and hence a period of time to be spent for capturing both images can be reduced.

### Modified Examples

The embodiments according to the present disclosure are not limited to the above-mentioned embodiments and can be variously modified.

For example, in the above, near-infrared light is emitted as the first-wavelength light from the transmitted illumination light sources. Receiving this near-infrared light, the phosphor is excited and visible light is radiated to the electronic component as the second-wavelength light. The use of the near-infrared light as the first-wavelength light can reduce, for example, influences to other resin product and the like. Further, interferences with visible light and the like emitted from an illumination unit to be used for other purpose can be prevented. However, if such a problem does not occur, for example, ultraviolet (UV) having a wavelength of about 400 nm or less or visible light having a wavelength of about 400 to 750 nm may be used as the first-wavelength light. In this case, a well-known phosphor excited by light having different wavelengths may appropriately be used. Otherwise, the wavelengths of the light to be used as the first- to third-wavelength light may appropriately be set.

The imaging unit including the above-mentioned illumination unit may be used as the imaging apparatus according to this embodiment. In this case, the first camera included in the imaging unit corresponds to the imaging section.

The structures of the turret and the nozzle units of the mounting head unit are not limited to the above-mentioned structures and design changes may appropriately be made.

Although, in each of the above-mentioned embodiments, the mounting head unit moves, upon mounting of the electronic component, in the plane (X-Y plane) that is substantially parallel to the mounting surface of the substrate, the substrate may move in that plane. Alternatively, both of the mounting head unit and the substrate W may move in that plane.

In the above-mentioned embodiment, for imaging the component sucked by the nozzle unit in the component mounting apparatus, the illumination apparatus according to this embodiment is used. However, for imaging predetermined materials, components, and the like for other fields and purposes, the illumination apparatus according to this embodiment may be used.

Out of the features of each embodiment described above, at least two features may be combined.

It should be noted that the present disclosure may also take the following configurations.

(1) An illumination apparatus, including:

a light source section including a light source configured to emit first-wavelength light having a first wavelength in order for an imaging apparatus to image a subject;

an irradiation section configured to convert the first-wavelength light from the light source into second-wavelength light having a second wavelength different from the first wavelength and to radiate the second-wavelength light to the subject; and a selection section configured to select the second-wavelength light as light to enter the imaging apparatus such that an image of the subject is captured using the second-wavelength light radiated to the subject.

(2) The illumination apparatus according to (1), in which

the irradiation section is configured to radiate the second-wavelength light from a back side of the subject to the subject.

(3) The illumination apparatus according to (1) or (2), in which

the irradiation section includes a reflection plate that is provided on the back side of the subject and is configured to convert the first-wavelength light into the second-wavelength light and reflect the second-wavelength light to the subject.

(4) The illumination apparatus according to (3), in which

the light source section is configured to emit the first-wavelength light from a front side of the subject to the reflection plate.

(5) The illumination apparatus according to (3) or (4), in which

the reflection plate includes a reflection surface that is provided perpendicular to a direction opposed to the subject and is configured to reflect the second-wavelength light to the subject in the opposed direction.

(6) The illumination apparatus according to any one of (1) to (5), in which

the light source section includes a different light source configured to radiate third-wavelength light having a third wavelength different from the first wavelength and the second wavelength to the subject,

the irradiation section is configured to absorb the third-wavelength light from the different light source, and

the selection section is configured to select the third-wavelength light as light to enter the imaging apparatus such that the image of the subject is captured using the third-wavelength light radiated to the subject.

(7) The illumination apparatus according to (6), in which

the light source section is configured to radiate the third-wavelength light from the front side of the subject to the subject.

(8) The illumination apparatus according to (6) or (7), in which

the different light source is provided flush with the light source.

The present disclosure contains subject matter related to that disclosed in Japanese Priority Patent Application JP 2012-070870 filed in the Japan Patent Office on Mar. 27, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An illumination apparatus, comprising:
a light source section including a light source configured to emit first-wavelength light having a first wavelength in order for an imaging apparatus to image a subject;
an irradiation section configured to convert the first-wavelength light from the light source into second-wavelength light having a second wavelength different from the first wavelength and to radiate the second-wavelength light to the subject; and
a selection section configured to select the second-wavelength light as light to enter the imaging apparatus such that an image of the subject is captured using the second-wavelength light radiated to the subject.

2. The illumination apparatus according to claim 1, wherein
the irradiation section is configured to radiate the second-wavelength light from a back side of the subject to the subject.

3. The illumination apparatus according to claim 1, wherein
the irradiation section includes a reflection plate that is provided on the back side of the subject and is configured to convert the first-wavelength light into the second-wavelength light and reflect the second-wavelength light to the subject.

4. The illumination apparatus according to claim 3, wherein
the light source section is configured to emit the first-wavelength light from a front side of the subject to the reflection plate.

5. The illumination apparatus according to claim 3, wherein
the reflection plate includes a reflection surface that is provided perpendicular to a direction opposed to the subject and is configured to reflect the second-wavelength light to the subject in the opposed direction.

6. The illumination apparatus according to claim 1, wherein
the light source section includes a different light source configured to radiate third-wavelength light having a third wavelength different from the first wavelength and the second wavelength to the subject,
the irradiation section is configured to absorb the third-wavelength light from the different light source, and
the selection section is configured to select the third-wavelength light as light to enter the imaging apparatus such that the image of the subject is captured using the third-wavelength light radiated to the subject.

7. The illumination apparatus according to claim 6, wherein
the light source section is configured to radiate the third-wavelength light from the front side of the subject to the subject.

8. The illumination apparatus according to claim 6, wherein
the different light source is provided flush with the light source.

9. An imaging apparatus, comprising:
an imaging section configured to capture an image of a subject;
a light source section including a light source configured to emit first-wavelength light having a first wavelength for the imaging;
an irradiation section configured to convert the first-wavelength light from the light source into second-wavelength light having a second wavelength different from the first wavelength and to radiate the second-wavelength light to the subject; and
a selection section configured to select the second-wavelength light as light to enter the imaging section such that the image of the subject is captured using the second-wavelength light radiated to the subject.

10. A component mounting apparatus, comprising:
a support unit configured to support a substrate;
a retaining section configured to be capable of retaining a component and mount the retained component on the substrate supported by the support unit;
an imaging section configured to capture an image of the component retained by the retaining section;
a light source section including a light source configured to emit first-wavelength light having a first wavelength for the imaging;
an irradiation section configured to convert the first-wavelength light from the light source into second-wavelength light having a second wavelength different from the first wavelength and to radiate the second-wavelength light to the component; and
a selection section configured to select the second-wavelength light as light to enter the imaging section such that an image of the component is captured using the second-wavelength light radiated to the component.

11. The component mounting apparatus according to claim 10, wherein
the irradiation section is provided to the retaining section on the back side of the component, and includes a reflection plate configured to convert the first-wavelength light into the second-wavelength light and reflect the second-wavelength light to the subject.

12. A method of manufacturing a substrate, comprising:
supporting a substrate by a support unit;
retaining a supplied component by a retaining section;
emitting first-wavelength light having a first wavelength in order for an imaging section to image the component retained by the retaining section;
converting the emitted first-wavelength light into second-wavelength light having a second wavelength different from the first wavelength and radiating the second-wavelength light to the component;
selecting the second-wavelength light as light to enter the imaging section, to thereby capture an image of the component using the second-wavelength light radiated to the component; and
performing component recognition based on the image of the component that is captured using the second-wavelength light and mounting the component retained by the retaining section on the substrate supported by the support unit based on a result of the component recognition.
